(19) United States
(12) Patent Application Publication
(10) Pub. No.: US 2026/0355679 A1
(43) Pub. Date: Nov. 12, 2026

(54) SYSTEM AND METHOD FOR MULTI-STAGE CARBON CAPTURE

(71) Applicant: GENERAL ELECTRIC TECHNOLOGY GMBH, Baden (CH)

(72) Inventors: Albert S. STELLA, Niskayuna, NY (US); Rinaldo Luigi MIORINI, Niskayuna, NY (US); Vitali V. LISSIANSKI, Niskayuna, NY (US)

(21) Appl. No.: 19/102,966

(22) PCT Filed: Aug. 16, 2022
(86) PCT No.: PCT/US2022/040502

§ 371 Date: Feb. 11, 2025

(51) Int. Cl. B01D 53/14; B01D 53/04; B01D 53/18

(52) U.S. Cl. CPC B01D 53/1475; B01D 53/0438; B01D 53/0454; B01D 53/0462; B01D 53/1412; B01D 53/1425; B01D 53/1437; B01D 53/185; B01D 2257/504; B01D 2259/40003; B01D 2259/4009

(57) ABSTRACT

A system includes a gas treatment system having first and second gas capture systems and a steam supply circuit. The first gas capture system is configured to capture a first portion of an undesirable gas from a combined cycle power plant. The second gas capture system is configured to capture a second portion of the undesirable gas from the combined cycle power plant, wherein the first and second gas capture systems are arranged in series relative to a fluid flow path through the combined cycle power plant. The steam supply circuit includes a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

### BACKGROUND

The present application relates generally to a system and method for treating a gas, such as an exhaust gas.

An industrial plant, such as a power plant, may produce a variety of gases, such as an exhaust gas of a combustion system. The combustion system may include a gas turbine engine, a reciprocating piston-cylinder engine, a furnace, a boiler, or other industrial equipment. These exhaust gases may include one or more undesirable gases, such as acid gases and/or greenhouse gases. For example, the undesirable gases may include carbon oxides such as carbon dioxide (CO₂) and carbon monoxide (CO), nitrogen oxides such as nitrogen dioxide (NO₂), and/or sulfur oxides such as sulfur dioxide (SO₂). CO₂ is both an acid gas and a greenhouse gas. Unfortunately, the atmospheric content of CO₂ has generally increased over thousands of years, and currently exceeds about 420 parts per million by volume (ppmv) or 643 parts per million by weight (ppmw) in the atmosphere. With various regulations and environmental concerns regarding global warming, it would be desirable to reduce the output of undesirable gases (e.g., CO₂) into the atmosphere, particularly for hydrocarbon fuel consuming equipment such as combustion systems.

### BRIEF DESCRIPTION

Certain embodiments commensurate in scope with the originally claimed subject matter are summarized below. These embodiments are not intended to limit the scope of the claimed embodiments, but rather these embodiments are intended only to provide a brief summary of possible forms of the subject matter. Indeed, the presently claimed embodiments may encompass a variety of forms that may be similar to or different from the embodiments set forth below.

In certain embodiments, a system includes a gas treatment system having first and second gas capture systems and a steam supply circuit. The first gas capture system is configured to capture a first portion of an undesirable gas from a combined cycle power plant. The second gas capture system is configured to capture a second portion of the undesirable gas from the combined cycle power plant, wherein the first and second gas capture systems are arranged in series relative to a fluid flow path through the combined cycle power plant. The steam supply circuit includes a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

In certain embodiments, a system includes a controller configured to control a first gas capture system of a gas treatment system to capture a first portion of an undesirable gas from a combined cycle power plant. The controller is configured to control a second gas capture system of the gas treatment system to capture a second portion of the undesirable gas from the combined cycle power plant, wherein the first and second gas capture systems are arranged in series relative to a fluid flow path through the combined cycle power plant. The controller is configured to control a supply of steam to the first and second gas capture systems via a steam supply circuit having a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

In certain embodiments, a method includes controlling a first gas capture system of a gas treatment system to capture a first portion of an undesirable gas from a combined cycle power plant. The method also includes controlling a second gas capture system of the gas treatment system to capture a second portion of the undesirable gas from the combined cycle power plant, wherein the first and second gas capture systems are arranged in series relative to a fluid flow path through the combined cycle power plant. The method also includes controlling a supply of steam to the first and second gas capture systems via a steam supply circuit having a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

### BRIEF DESCRIPTION OF THE DRAWINGS

These and other features, aspects, and advantages of the presently disclosed techniques will become better understood when the following detailed description is read with reference to the accompanying drawings in which like characters represent like parts throughout the drawings, wherein:

FIG. 1 is a schematic view of an embodiment of a combined cycle power plant having a gas turbine system, a heat recovery steam generator (HRSG), a steam turbine system, and a multi-stage gas treatment system having a plurality of gas capture systems configured to capture an undesirable gas (e.g., CO₂).

FIG. 2 is a schematic of an embodiment of a gas capture system of the multi-stage gas treatment system of FIG. 1, illustrating a sorbent-based gas capture system.

FIG. 3 is a schematic of an embodiment of a gas capture system of the multi-stage gas treatment system of FIG. 1, illustrating a solvent-based gas capture system.

### DETAILED DESCRIPTION

One or more specific embodiments of the presently disclosed systems are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the presently disclosed embodiments, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include gas treatment systems and methods to reduce the carbon footprint of combustion systems, such as combined cycle power plants, such that the carbon footprint is at least carbon neutral or carbon negative. Carbon neutral is a state of net-zero CO₂ emissions, wherein the amount of CO₂ in the exhaust gas equals the amount of CO₂ in the inlet air to a process. Carbon negative is a state of net-negative CO₂ emissions, wherein the amount of CO₂ in the exhaust gas is less than the amount of CO₂ emitted to the atmosphere by a process. While the disclosed embodiments are illustrated and described in context of CO₂ removal for combustion systems, the disclosed embodiments may be used for the removal of any undesirable gases, including but not limited to carbon oxides (e.g., CO₂, CO), nitrogen oxides (e.g., NO₂), sulfur oxides (e.g., SO₂), and various other acid gases and/or greenhouse gases. As discussed below, the combustion systems may be associated with a combined cycle power plant, a simple cycle gas turbine engine, a reciprocating piston-cylinder engine, a furnace, a boiler, or other industrial equipment. The combined cycle power plant may include a gas turbine engine that drives an electrical generator, a heat recovery steam generator (HRSG) that uses heat from the exhaust gas of the gas turbine engine to generate steam, and a steam turbine driven by the steam to drive an electrical generator.

With the foregoing in mind, the disclosed embodiments include a plurality of gas treatment stages, which are configured to remove undesirable gases (e.g., CO₂) from the intake air and/or the exhaust gas of the combustion systems to help achieve net neutral or net negative emissions. The plurality of gas treatment stages may include one or more gas treatment systems disposed upstream of a compressor and/or combustor, one or more gas treatment systems disposed downstream of a gas turbine and/or the HRSG, or a combination thereof. The gas treatment systems may include sorbent-based gas treatment systems, solvent-based gas treatment systems, or a combination thereof. For example, the sorbent-based gas treatment systems are configured to adsorb the undesirable gases into a sorbent material, and then subsequently desorb the undesirable gases from the sorbent material using a heat source (e.g., steam from the HRSG). The adsorption process is exothermic, while the desorption process is endothermic. By further example, the solvent-based gas treatment systems may include an absorber configured to absorb the undesirable gas into a solvent, and a regenerator configured to strip the undesirable gas from the solvent using steam (e.g., steam from the HRSG). Thus, in both types of gas treatment systems, the steam from the HRSG may be used to facilitate the removal and capture of the undesirable gases (e.g., CO₂). Additionally or alternatively, in one or both types of gas treatment systems, one or more types of waste heat recovery may be used as a heat source for the removal and capture of the undesirable gases (e.g., CO₂). For example, the gas treatment systems may use waste heat recovered from cooling one or more electrical generators, waste heat recovered from cooling (or intercooling) a compressed gas of one or more compressors, waste heat recovered from cooling other equipment in the combined cycle power plant, or a combination thereof. Various aspects and embodiments of the gas treatment systems are discussed in further detail below.

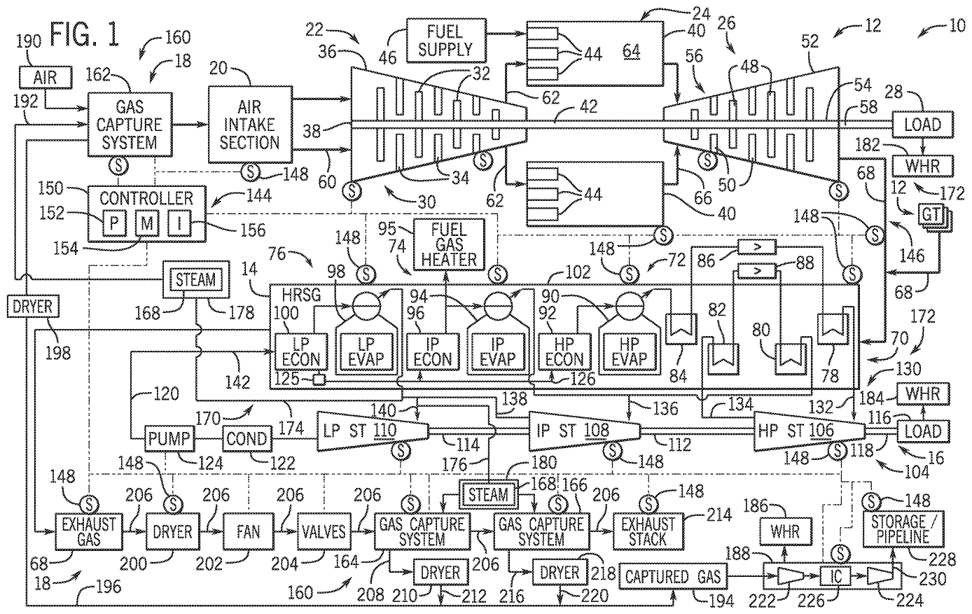

FIG. 1 is a schematic of an embodiment of a combined cycle power plant 10 having a gas turbine system 12, a heat recovery steam generator (HRSG) 14, a steam turbine system 16, and a multi-stage gas treatment system (GTS) 18. As discussed in further detail below, the multi-stage gas treatment system 18 is configured to treat one or more intake and/or exhaust gases in the combined cycle power plant 10. The various features and stages of the gas treatment system 18 are discussed in further detail below, and the various features and stages may be used in any suitable combination with one another. However, before moving on to the gas treatment system 18, the combined cycle power plant 10 will be described as one possible context for use of the gas treatment system 18.

The gas turbine system 12 cycle is often referred to as the “topping cycle,” whereas the steam turbine system 16 cycle is often referred to as the “bottoming cycle.” By combining these two cycles as illustrated in FIG. 1, the combined cycle power plant 10 may lead to greater efficiencies in both cycles. In particular, exhaust heat from the topping cycle may be captured and used to generate steam in the HRSG 14 for use in the bottoming cycle. However, the HRSG 14 may be configured to generate and supply steam for other uses in the combined cycle power plant 10, including the gas treatment system 18. For example, the gas treatment system 18 may be configured to use steam generated in the HRSG 14 to facilitate the separation and capture of undesirable gases, such as carbon capture (e.g., CO₂ capture) in sorbent-based gas treatment systems and/or solvent-based gas treatment systems.

As illustrated, the gas turbine system 12 includes an air intake section 20, a compressor section 22, a combustor section 24, a turbine section 26, and a load 28, such as an electrical generator. The air intake section 20 may include one or more air filters, anti-icing systems, fluid injection systems (e.g., temperature control fluids), silencer baffles, or any combination thereof. The compressor section 22 includes multiple compressor stages 30, each having multiple rotating compressor blades 32 coupled to a compressor shaft 38 and multiple stationary compressor vanes 34 coupled to a compressor casing 36. The combustor section 24 includes one or more combustors 40. A shaft 42 extends between the compressor section 22 and the turbine section 26. Each combustor 40 includes one or more fuel nozzles 44 coupled to one or more fuel supplies 46, which may supply fuel through primary and secondary fuel circuits. The fuel supplies 46 may supply natural gas, syngas, biofuel, fuel oils, or any combination of liquid and gas fuels. The turbine section 26 includes multiple turbine stages 56, each having multiple rotating turbine blades 48 coupled to a turbine shaft 54 and multiple stationary turbine vanes 50 coupled to a turbine casing 52. The turbine shaft 54 also connects to the load 28 via a shaft 58.

In operation, the gas turbine system 12 routes an air intake flow 60 from the air intake section 20 into the compressor section 22. The compressor section 22 progressively compresses the air intake flow 60 in the stages 30 and delivers a compressed airflow 62 into the one or more combustors 40. The one or more combustors 40 receive fuel from the fuel supply 46, route the fuel through the fuel nozzles 44, and combust the fuel with the compressed airflow 62 to generate hot combustion gases in a combustion chamber 64 within the combustor 40. The one or more combustors 40 then route a hot combustion gas flow 66 into the turbine section 26. The turbine section 26 progressively expands the hot combustion gas flow 66 and drives rotation of the turbine blades 48 in the stages 56 before discharging an exhaust gas flow 68. As the hot combustion gas flow 66 drives rotation of the turbine blades 48, the turbine blades 48 drive rotation of the turbine shaft 54, the shafts 42 and 58, and the compressor shaft 38. Accordingly, the turbine section 26 drives rotation of the compressor section 22 and the load 28. The exhaust gas flow 68 may be partially or entirely directed to flow through the HRSG 14 to enable heat recovery and steam generation. In certain embodiments, one or more additional gas turbine engines 12 may be included as part of the combined cycle power plant 10, wherein the additional gas turbine engines 12 may discharge exhaust gas flows 68 to the HRSG 14. Thus, the collective exhaust gas flow 68 from the gas turbine engines 14 (e.g., 1, 2, 3, 4, or more) may pass through the HRSG 14 to generate steam for the steam turbine system 16, and the exhaust gas flow 68 is then treated by the gas treatment system 18.

The HRSG 14 may include a plurality of heat exchangers and/or heat exchange components 70 disposed in different sections, such as a high pressure (HP) section 72, an intermediate pressure (IP) section 74, and a low pressure (LP) section 76. The components 70 may include economizers, evaporators, superheaters, or any combination thereof, in each of the HP, IP, and LP sections 72, 74, and 76. The components 70 may be coupled together via various conduits and headers, and the HRSG 14 may route one or more flows of steam (e.g., low pressure steam, intermediate pressure steam, and high pressure steam) to the steam turbine system 16. In the illustrated embodiment, the components 70 of the HRSG 14 include a finishing high pressure superheater 78, a secondary re-heater 80, a primary re-heater 82, a primary high pressure superheater 84, an inter-stage attemperator 86, an inter-stage attemperator 88, a high pressure evaporator 90 (HP EVAP), a high pressure economizer 92 (HP ECON), an intermediate pressure evaporator 94 (IP EVAP), an intermediate pressure economizer 96 (IP ECON), a low pressure evaporator 98 (LP EVAP), and a low pressure economizer 100 (LP ECON). The HRSG 14 also includes an enclosure or duct 102 housing the various components 70. The functionality of the components 70 is discussed in further detail below.

The steam turbine system 16 includes a steam turbine 104 having a high pressure steam turbine (HP ST) 106, an intermediate pressure steam turbine (IP ST) 108, and a low pressure steam turbine (LP ST) 110, which are coupled together via shafts 112 and 114. Additionally, the steam turbine 104 may be coupled to a load 116 via a shaft 118. Similar to the load 28, the load 116 may include an electrical generator. The HRSG 14 may be configured to generate a high pressure steam for the high pressure steam turbine 106, an intermediate pressure steam for the intermediate pressure steam turbine 108, and a low pressure steam for the low pressure steam turbine 110. In certain embodiments, an exhaust from the high pressure steam turbine 106 may be routed into the intermediate pressure steam turbine 108 through the primary re-heater 82, the inter-stage attemperator 88, and the secondary re-heater 80 within the HRSG 14, and an exhaust from the intermediate pressure steam turbine 108 may be routed into the low pressure steam turbine 110. The steam turbine 104 may discharge a condensate 120 (or the steam may be condensed in a condenser 122 downstream from the steam turbine 104), such that the condensate 120 can be pumped back into the HRSG 14 via one or more pumps 124.

In operation, the exhaust gas flow 68 passes through the HRSG 14 and transfers heat to the components 70 to generate steam for driving the steam turbine 104. The exhaust steam from the low pressure steam turbine 110 may be directed into the condenser 122 to form the condensate 120. The condensate 120 from the condenser 122 may, in turn, be directed into the low pressure section 76 of the HRSG 14 with the aid of the pump 124. The condensate 120 may then flow through the low pressure economizer 100, which is configured to heat a feedwater 126 (including the condensate 120) with the exhaust gas flow 68. From the low pressure economizer 100, the feedwater 126 may flow into the low pressure evaporator 98. The feedwater 126 from low pressure economizer 100 may be directed toward the intermediate pressure economizer 96 and the high pressure economizer 92 with the aid of a pump 125. Steam from the low pressure evaporator 98 may be directed to the low pressure steam turbine 110. Likewise, from the intermediate pressure economizer 96, the feedwater 126 may be routed into the intermediate pressure evaporator 94 and/or toward the high pressure economizer 92. In addition, steam from the intermediate pressure economizer 96 may be routed to a fuel gas heater 95, where the steam may be used to heat fuel gas for use in the combustion chamber 64 of the gas turbine system 12. Steam from the intermediate pressure evaporator 94 may be routed to the intermediate steam turbine 108.

The feedwater 126 from the high pressure economizer 92 may be routed into the high pressure evaporator 90. Steam from the high pressure evaporator 90 may be routed into the primary high pressure superheater 84 and the finishing high pressure superheater 78, where the steam is superheated and eventually routed to the high pressure steam turbine 106. The inter-stage attemperator 86 may be located in between the primary high pressure superheater 84 and the finishing high pressure superheater 78. The inter-stage attemperator 86 may enable more robust control of the exhaust temperature of steam from the finishing high pressure superheater 78. Specifically, the inter-stage attemperator 86 may be configured to control the temperature of steam exiting the finishing high pressure superheater 78 by injecting a cooler feedwater spray into the superheated steam upstream of the finishing high pressure superheater 78 whenever the exhaust temperature of the steam exiting the finishing high pressure superheater 78 exceeds a predetermined value.

In addition, an exhaust from the high pressure steam turbine 106 may be directed into the primary re-heater 82 and the secondary re-heater 80, where it may be re-heated before being directed into the intermediate pressure steam turbine 108. The primary re-heater 82 and the secondary re-heater 80 may also be associated with the inter-stage attemperator 88, which is configured to control the exhaust steam temperature from the re-heaters. Specifically, the inter-stage attemperator 88 may be configured to control the temperature of steam exiting the secondary re-heater 80 by injecting cooler feedwater spray into the superheated steam upstream of the secondary re-heater 80 whenever the exhaust temperature of the steam exiting the secondary re-heater 80 exceeds a predetermined value. The arrangement of the components 70 of the HRSG 14 is merely one possible example for use with the combined cycle power plant 10 and the gas treatment system 18, and the components 70 may be arranged differently within the scope of the present disclosure.

The combined cycle power plant 10 further includes a fluid connection system 130 between stages of the HRSG 14 and stages of the steam turbine system 16. For example, the fluid connection system 130 includes a high pressure steam supply conduit or line 132 coupled to the finishing high pressure superheater 78 and an inlet into the high pressure steam turbine 106, and a discharge or return line 134 coupled to an outlet of the high pressure steam turbine 106 and the primary re-heater 82. The fluid connection system 130 also includes an intermediate pressure steam supply conduit or line 136 and a discharge or return line 138. The intermediate pressure steam supply line 136 is fluidly coupled to outlets of the intermediate pressure evaporator 94 and the secondary re-heater 80 and an inlet into the intermediate pressure steam turbine 108. The discharge or return line 138 is fluidly coupled to an outlet of the intermediate pressure steam turbine 108 and an inlet into the low pressure steam turbine 110. The fluid connection system 130 also includes a low pressure steam supply conduit or line 140 and a discharge or return line 142. The low pressure steam supply line 140 is fluidly coupled to outlets of the low pressure evaporator 98 and the discharge or return line 138 from intermediate pressure steam turbine 108 and to an inlet into the low pressure steam turbine 110. The discharge or return line 142 is fluidly coupled to an outlet of the low pressure steam turbine 110 and an inlet into the low pressure economizer 100. As discussed above, the return line 142 includes the condenser 122 and the pump 124.

The combined cycle power plant 10 may include a control system 144 communicatively coupled with a monitoring system 146, wherein the control system 144 and the monitoring system 146 are communicatively coupled with various components of the gas turbine system 12, the HRSG 14, the steam turbine system 16, and the gas treatment system 18. The monitoring system 146 is configured to monitor a plurality of sensors 148, designated as “S”, distributed throughout the combined cycle power plant 10. The control system 144 includes a controller 150, wherein the controller 150 includes one or more processors 152, memory 154, and instructions 156 stored on the memory 154 and executable by the processor(s) 152 to perform various control functions for operating the gas turbine system 12, the HRSG 14, the steam turbine system 16, and the gas treatment system 18. In certain embodiments, the control system 144 may communicate information (e.g., sensor feedback, alerts, alarms, etc.) to a user interface, cloud storage, a remote computer system, or any combination thereof.

The sensors 148 may be communicatively coupled to the control system 144 via communication wires or wireless communication circuitry. The sensors 148 may be disposed at one or more locations in the air intake section 20, the compressor section 22, the combustor section 24, the turbine section 26, the HRSG 14, the steam turbine system 16, and the gas treatment system 18. For example, the sensors 148 may be disposed at one or more locations in each of the high pressure steam turbine 106, the intermediate pressure steam turbine 108, and the low pressure steam turbine 110, thereby enabling monitoring of steam properties (e.g., temperature, pressure, etc.) at the various locations. The sensors 148 also may be disposed along each of the lines 132, 134, 136, 138, 140, and 142 of the fluid connection system 130, thereby helping to monitor various fluid parameters between the HRSG 14, the steam turbines 106, 108, and 110, and the gas treatment system 18. Additionally, the sensors 148 may be coupled to and/or distributed throughout the gas treatment system 18 to enable monitoring and control of the gas treatment (e.g., gas capture) from various intake and/or exhaust flows. In certain embodiments, the sensors 148 may include flow sensors, pressure sensors, temperature sensors, fluid composition sensors, flame sensors, vibration sensors, clearance sensors, trip sensors, or any combination thereof. The fluid composition sensors may monitor composition levels of various undesirable gases, such as composition levels of carbon oxides (e.g., CO₂, CO), nitrogen oxides (e.g., NO₂), sulfur oxides (e.g., SO₂), and various other acid gases and/or greenhouse gases as well as oxygen, hydrogen and unreacted fuel gas content. Accordingly, the sensor feedback from the sensors 148 may be used to adjust various aspects of the gas treatment system 18 to reduce the carbon footprint of the combined cycle power plant 10, such as by substantially removing undesirable gases (e.g., CO₂) such that the carbon footprint is at least carbon neutral or carbon negative. Additional details of the monitoring and control of the gas treatment system 18 are discussed further below.

As discussed in further detail below, the gas treatment system 18 is configured to remove and/or capture one or more undesirable gases (e.g., exhaust emissions gases, acid gases, greenhouse gases, etc.) from an air intake flow 60 into the gas turbine engine 12 (e.g., upstream of the compressor section 22 and/or combustor section 24) and/or the exhaust gas flow 68 (e.g., downstream from the turbine section 26 and/or the HRSG 14). The undesirable gases are intended to cover any gases that may be undesirable in the air intake flow 60 and/or exhaust gas flow 68. For example, the undesirable gases may include acid gases and/or greenhouse gases. By further example, the undesirable gases may include any gases typically subject to regulation, including but not limited to, carbon oxides (CO_{X}) such as carbon dioxide (CO₂) and carbon monoxide (CO), nitrogen oxides (NO_{X}), sulfur oxides (SO_{X}) such as sulfur dioxide (SO₂), methane (CH₄) or any combination thereof. The disclosed embodiments are particularly well suited for gas adsorption or absorption of CO₂ from the air intake flow 60 and/or exhaust gas flow 68. However, the following discussion is intended to cover each of these examples when referring to undesirable gases.

The gas treatment system 18 may include a plurality of gas capture systems 160 (e.g., gas capture systems 162, 164, and 166) disposed throughout the combined cycle power plant 10 to treat a gas flow (e.g., intake airflow, fuel flow, exhaust flow, etc.). Each of the gas capture systems 160 (e.g., 162, 164, and 166) may be configured to use one or more heat sources to facilitate gas capture, wherein the gas capture systems 160 may include sorbent-based gas capture systems, solvent-based gas capture systems, or a combination thereof. As discussed below, the heat sources may include heated fluid 168 (e.g., steam and/or heated water) extracted from the HRSG 14 and/or the steam turbine system 16 and supplied to the gas capture systems 160 via a steam supply system 170 (e.g., steam supply circuit), waste heat recovered by a waste heat recovery (WHR) system 172 of the combined cycle power plant 10, or a combination thereof. The steam supply system 170 may include steam supply conduits or lines 174 and 176 coupled to the HRSG 14 and/or the steam turbine system 16 at one or more locations. In the illustrated embodiment, the steam supply lines 174 and 176 may be coupled to the HRSG 14 and/or the steam turbine system 16 at or between low pressure sections and intermediate pressure sections, such as between the low pressure steam turbine 110 and the intermediate pressure steam turbine 108 and/or between the LP section 76 and the IP section 74 of the HRSG 14. However, in certain embodiments, the steam supply system 170 may be selectively coupled to any one, multiple, or all of the components of the HRSG 14 (e.g., one or more components or locations in each of the HP, IP, and LP sections 72, 74, and 76), and/or any one, multiple, or all stages of the steam turbine system 16 (e.g., HP, IP, and LP steam turbines 106, 108, and 110), such that the heated fluid 168 (e.g., steam and/or heated water) can be extracted at one or more pressures, temperatures, or conditions for use in the gas capture systems 160. For example, the control system 144 may be configured to control various valves coupled to steam lines to control steam flow from the various components of the HRSG 14 and the stages of the steam turbine system 16. Additionally, in certain embodiments, the heated fluid 168 (e.g., steam and/or heated water) may be extracted from other sources, such as a waste heat steam generator using waste heat from the waste heat recovery system 172 to generate steam. The gas treatment system 18, via control by the control system 144, is also configured to combine the steam 18 from various steam sources (e.g., HRSG 14, steam turbine system 16, waste heat recovery system 172, waste heat steam generator, etc.) to provide a mixed steam with desired steam characteristics, e.g., steam temperature and associated pressure between upper and lower temperature thresholds. In addition, the quality of the steam (saturated or superheated) can be monitored to meet specific heating requirements of the gas treatment system 18.

The control system 144 and the monitoring system 146 are communicatively coupled to the gas treatment system 18, including the various gas capture systems 160, to provide control of the gas treatment and capture processes, including control of the heated fluid 168 (e.g., steam and/or heated water) being used by the gas capture systems 160. The steam can be applied to the gas treatment system 18 as indirect heating through a heat exchanger process or direct heating of the CO₂ loaded sorbent or solvent. If the monitoring system 146 (e.g., sensors 148) indicates that the temperature of the extracted heated fluid 168 (e.g., steam and/or heated water) is above an upper temperature threshold, then the control system 144 may be configured to control the gas treatment system 18 to attemperate or cool the heated fluid 168 (e.g., via attemperator, cooler, or heat exchanger) to lower the steam temperature to be within upper and lower temperature thresholds. If the monitoring system 146 (e.g., sensors 148) indicates that the temperature of the extracted heated fluid 168 (e.g., steam and/or heated water) is below a lower temperature threshold, then the control system 144 may be configured to control the gas treatment system 18 to heat the heated fluid 168 (e.g., via heater or heat exchanger) to increase the steam temperature to be within the upper and lower temperature thresholds. In certain embodiments, the upper and lower temperature thresholds may be approximately 80 to 120 degrees Celsius for the gas capture systems 160 using sorbent-materials (e.g., sorbent-based gas capture systems). For temperature adjustments, the steam supply lines 174 and 176 may include respective heat exchangers 178 and 180 configured to adjust the heated fluid 168 (e.g., steam and/or heated water) being supplied to the gas capture systems 160. The heat exchangers 178 and 180 may use another fluid to heat or cool the steam. For example, the waste heat recovery system 172 may be configured to exchange heat (e.g., via heat exchange fluids) with the heat exchangers 178 and 180 to heat or cool the heated fluid 168 (e.g., steam and/or heated water) to be within the upper and lower temperature thresholds. The control system 144 may be coupled to various valves, pressure regulators, and sensors 148 to help control the respective flows through the heat exchangers 178 and 180, thereby controlling the heat exchange and resulting temperatures of the heated fluid 168 (e.g., steam and/or heated water). Additionally or alternatively, as noted above, the waste heat recovery system 172 may be configured to transfer heat between the waste heat and the heated fluid 168 (e.g., steam and/or heated water), such as in a waste heat steam generator, to adjust the temperature of the heated fluid 168. The waste heat recovery system 172 also may be used to improve the efficiency of the combined cycle power plant 10 in other ways, such as by providing heat to other equipment throughout the combined cycle power plant 10.

The waste heat recovery system 172 may include a plurality of distributed waste heat recovery systems 182, 184, and 186. The waste heat recovery system 182 is coupled to the load 28 (e.g., electrical generator) of the gas turbine engine 12, the waste heat recovery system 184 is coupled to the load 116 (e.g., electrical generator) of the steam turbine system 16, and the waste heat recovery system 186 is coupled to a compression system 188 of the gas treatment system 18. The waste heat recovery systems 182, 184, and 186 may include one more heat exchangers configured to transfer heat between the respective heat generating components (e.g., 28, 116, and 188) and one or more fluids. For example, each waste heat recovery systems 182, 184, and 186 may transfer heat between a first fluid (e.g., a coolant and/or lubricant in the heat generating components 28, 116, and 188) and a second fluid via a first heat exchanger. The second fluid may be water used directly to generate steam in a waste heat steam generator, or a working fluid used indirectly to transfer heat to water (e.g., via a second heat exchanger) to generate steam. In some embodiments, the waste heat recovery system 172 may include one or more distributed waste heat recovery systems coupled to other machinery and equipment in the combined cycle power plant, including but not limited to electric motors, pumps, compressors, chemical reactors, air separation units (ASUs), or any combination thereof. In some embodiments, the waste heat recovery system 172 may be configured to convey a heated fluid (e.g., water, coolant, lubricant, etc.) to provide heat to the gas capture systems 160, wherein the heated fluid may be used alone or in combination with the heated fluid 168 (e.g., steam and/or heated water) as the heat source for the gas capture systems 160.

In certain embodiments, the gas capture systems 160 (e.g., 162, 164, and 166) may be arranged in series (e.g., multiple stages), in parallel, or a combination thereof, relative to a direction of flow through the combined cycle power plant 10. However, the illustrated embodiment includes at least two of the gas capture systems 160 arranged in series, such that multiple stages of gas capture help to sequentially reduce the content of undesirable gases to net neutral or net negative capture status. For example, the gas treatment system 18 may include only a plurality of the gas capture system 162, only a plurality of the gas capture system 164, only a plurality of the gas capture system 166, a combination with the gas capture systems 162 and 164, a combination with the gas capture systems 162 and 166, a combination with the gas capture systems 164 and 166, all of the gas capture systems 162, 164, and 166, or any suitable multi-stage arrangement of 2, 3, 4, 5, 6, 7, 8, 9, 10, or more gas capture systems 160. Additionally, the multi-stage gas treatment system 18 may include the same or different gas capture systems 160 at the various locations, such as different sizes or flow capacities, different internal surface areas along the flow paths, different flow rates along the flow paths, different numbers of flow paths, different geometries or tortuous configurations of the flow paths, different residence times along the flow paths, different gas capture technologies (e.g., sorbent-based gas capture and/or solvent-based gas capture), specifications to handle high or low concentrations of undesirable gases, or any combination thereof. For example, the gas capture systems 162 and 166 may be designed to handle low concentrations of undesirable gases, whereas the gas capture system 164 may be designed to handle high concentrations of undesirable gases. In some embodiments, the concentration of undesirable gases in gas capture systems 162 and 166 may be more than 100 times lower than in gas capture system 164.

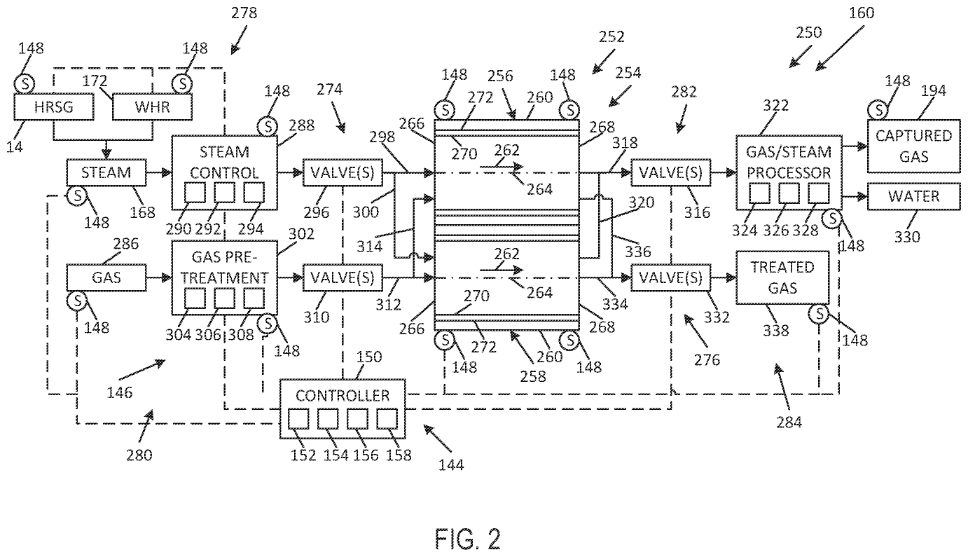

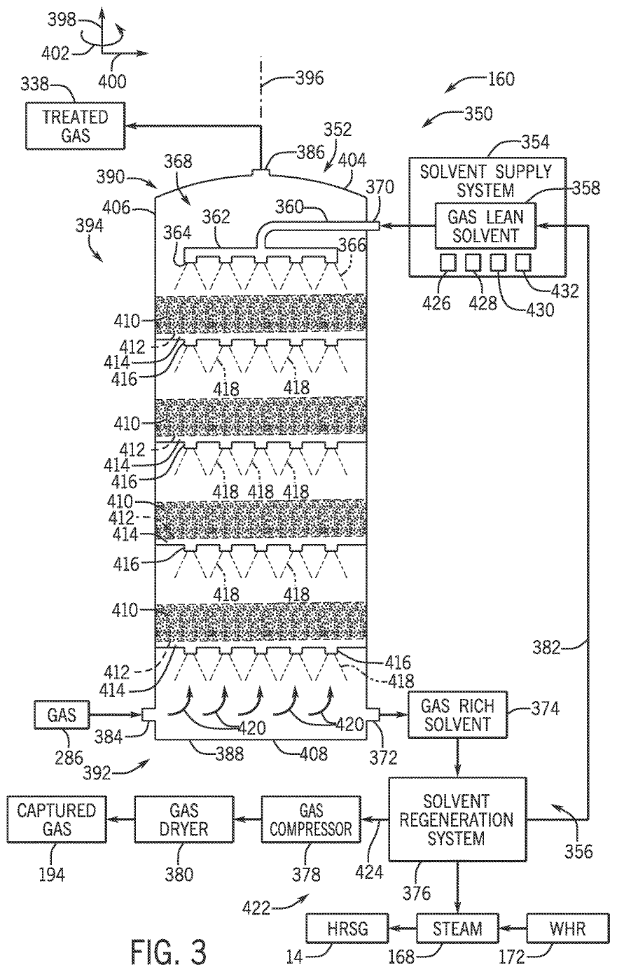

The gas capture systems 162, 164, and 166 may differ in design and gas treatment capacities at least partially due to their placements in the combined cycle power plant 10. In the illustrated embodiment, the gas capture system 162 is coupled to the combined cycle power plant 10 along the air intake flow 60 (e.g., at the air intake section 20), while the gas capture systems 164 and 166 are coupled to the combined cycle power plant 10 along the exhaust gas flow 68 (e.g., downstream from the turbine section 26). The gas capture system 162 is configured to capture undesirable gases (e.g., CO₂) from a flow of air (airflow) 190 prior to entry and/or combustion in the gas turbine engine 12, wherein the gas capture system 162 uses the heated fluid 168 (e.g., steam and/or heated water) as a heat source. As discussed in further detail below, the gas capture system 162 may include a sorbent-based gas capture system, a solvent-based gas capture system, or a combination thereof. Examples are presented below with reference to FIGS. 2 and 3. The steam supply line 174 is coupled to the gas capture system 162, and provides the heated fluid 168 (e.g., steam and/or heated water) as a steam flow and/or water flow as indicated by arrow 192. As discussed above, the steam supply system 170 may include one or more steam supply lines (e.g., line 174) coupled to the HRSG 14 and/or the steam turbine system 16 at one or more locations, such that the heated fluid 168 (e.g., steam and/or heated water) can be supplied to the gas capture system 162 at a variety of conditions (e.g., pressures, temperatures, steam content, water content, etc.). Although illustrated at the air intake section 20, the gas capture system 162 may be configured to treat an airflow 190 at any location throughout the combined cycle power plant 10, including airflows upstream from the compressor section 22, between compressor stages 30 of the compressor section 22, downstream from the compressor section 22 and upstream from the combustor section 24, other locations including airflows, or a combination thereof. In certain embodiments, the gas capture system 162 may be configured to treat a recirculated exhaust gas (EGR), such as the exhaust gas 68 recirculated into the compressor section 22, and thus the gas capture system 162 may be sized to handle greater concentrations of undesirable gases that are recirculated as part of the EGR process. The gas capture system 162 generally treats the airflow 190 (or EGR flow) directed into the gas turbine engine 12, such that the concentration of undesirable gases is low, while also routing a captured gas 194 to the compression system 188 via a discharge conduit or line 196. The discharge line 196 also may include post-processing equipment, such as a dryer 198 configured to remove moisture content from the captured gas 194.

As further illustrated in FIG. 1, the gas capture systems 164 and 166 are coupled to the combined cycle power plant 10 along the exhaust gas flow 68 downstream from the gas turbine section 26 and the HRSG 14. In the illustrated positions, the gas capture systems 164 and 166 are configured to remove undesirable gas from the exhaust gas flow 68 discharged from the gas turbine engine 12 and the HRSG 14. In certain embodiments, the gas capture systems 164 and 166 may be configured to treat an exhaust gas flow at any location throughout the combined cycle power plant 10, including exhaust gas flows upstream from the HRSG 14, between sections (e.g., HP, IP, and LP sections 72, 74, and 76) of the HRSG 14, downstream from the HRSG 14, independent exhaust gas flows relative to the exhaust gas flow 68, or any combination thereof. For example, the independent exhaust gas flows may originate from other combustion systems, such as furnaces, boilers, reciprocating piston-cylinder engines, or any combination thereof. In the illustrated embodiment, the gas capture system 164 is disposed upstream from the gas capture system 166, such that the gas capture systems 164 and 166 may represent first and second gas capture stages along the exhaust gas flow 68.

Along the exhaust gas flow 68, the gas treatment system 18 may include one or more dryers 200, one or more fans 202, and one or more valves 204 along an exhaust flow path (e.g., exhaust duct) 206 upstream from the gas capture systems 164 and 166. The one or more dryers 200 are configured to remove moisture (e.g., water content or steam) and dry the exhaust gas flow 68. The one or more fans 202 (e.g., electric motor driven fans) are configured to boost a pressure and/or flow rate of the exhaust gas flow 68. The one or more valves 204 are configured to adjust a pressure, flow rate, and/or distribution of the exhaust gas flow 68 into the gas capture systems 164 and 166. In certain embodiments, the illustrated dryers 200, fans 202, and valves 204 are partially or entirely shared by the gas capture systems 164 and 166. However, in some embodiments, one or more dryers 200, fans 202, and valves 204 may be disposed independently upstream of each of the gas capture systems 164 and 166. The exhaust gas flow 68 flows through each of the gas capture systems 164 and 166 in series for staged removal of the undesirable gases to achieve desired capture amounts.

The gas capture system 164 removes a portion of the undesirable gases from the exhaust gas flow 68, discharges a treated exhaust gas flow (e.g., upstream or first stage treated exhaust gas) to the gas capture system 166, and discharges a captured gas portion of the captured gas 194 as indicated by discharge conduit or line 208. As discussed in further detail below, the gas capture system 164 may include a sorbent-based gas capture system, a solvent-based gas capture system, or a combination thereof. Examples are presented below with reference to FIGS. 2 and 3. The steam supply line 176 is coupled to the gas capture system 164, and provides the heated fluid 168 (e.g., steam and/or heated water) as a steam flow and/or a heated water flow into the gas capture system 164. As discussed above, the steam supply system 170 may include one or more steam supply lines (e.g., line 176) coupled to the HRSG 14 and/or the steam turbine system 16 at one or more locations, such that the heated fluid 168 (e.g., steam and/or heated water) can be supplied to the gas capture system 164 at a variety of conditions (e.g., pressures, temperatures, steam content, water content, etc.). The discharge line 208 may include a variety of post-processing equipment, such as a dryer 210 configured to remove moisture (e.g., water content or steam) and dry the captured gas 194 to generated dried captured gas as indicated by discharge conduit or line 212. The captured gas 194 then flows to the compression system 188 as discussed below.

Similarly, the gas capture system 166 removes a portion of the undesirable gases from the exhaust gas flow 68, discharges a treated exhaust gas flow (e.g., downstream or second stage treated exhaust gas) to a subsequent gas capture system or an exhaust stack 214, and discharges a captured gas portion of the captured gas 194 as indicated by discharge conduit or line 216. As discussed in further detail below, the gas capture system 166 may include a sorbent-based gas capture system, a solvent-based gas capture system, or a combination thereof. Examples are presented below with reference to FIGS. 2 and 3. The steam supply line 176 is coupled to the gas capture system 166, and provides the heated fluid 168 (e.g., steam and/or heated water) as a steam flow and/or a heated water flow into the gas capture system 166. As discussed above, the steam supply system 170 may include one or more steam supply lines (e.g., line 176) coupled to the HRSG 14 and/or the steam turbine system 16 at one or more locations, such that the heated fluid 168 (e.g., steam and/or heated water) can be supplied to the gas capture system 166 at a variety of conditions (e.g., pressures, temperatures, steam content, water content, etc.). The discharge line 216 may include a variety of post-processing equipment, such as a dryer 218 configured to remove moisture (e.g., water content or steam) and dry the captured gas 194 to generated dried captured gas as indicated by discharge conduit or line 220. The captured gas 194 then flows to the compression system 188 as discussed below.

The compression system 188 may include a single stage or multistage compression system. In the illustrated embodiment, the compression system 188 includes one or more first or upstream compressors 222 configured to compress the captured gas 194 in one or more upstream stages, one or more second or downstream compressors 224 configured to compress the captured gas 194 after compression by the compressors 222, and one or more intercoolers 226 configured to cool the captured gas 194 between the compressors 222 and 224. The intercoolers 226 may include heat exchangers, gas dryers, and/or other equipment to facilitate the gas compression. The compression system 188 outputs a compressed captured gas 194 to a storage unit and/or pipeline 228 at a specified pressure and gas purity, as indicated by discharge conduit or line 230. As discussed above, the waste heat recovery system 186 may be coupled to the compression system 188 to extract waste heat used as a heat source for the gas treatment system 18 (e.g., gas capture systems 160), improved plant efficiency, or other uses. The waste heat recovery system 186 may be coupled to one or more of the compressors 222, the compressors 224, and/or the intercoolers 226.

As discussed above, the gas capture systems 162, 164, and 166 may differ due to their placements in the combined cycle power plant 10. For example, the gas capture system 162 may be designed to handle low concentrations of undesirable gases, such as concentrations of CO₂ at or near typical atmospheric concentration levels, thereby ensuring that the gas capture system 162 is configured to reduce the concentration of CO₂ to levels below the typical atmospheric concentration levels (e.g., below about 420 ppmv of CO₂). For example, the gas capture system 162 may be configured to reduce the concentration of CO₂ by at least 50, 60, 70, 80, or 90 percent of the typical atmospheric concentration levels. In certain embodiments, to achieve such concentration levels, the gas capture system 162 may be sized substantially larger than the gas capture systems 164 and 166 to enable sufficient resident time of the gas (e.g., air being treated within the gas capture system 162). In certain embodiments, the gas capture system 162 may be excluded from the gas treatment system 18.

In contrast, the gas capture system 164 may be designed to handle high concentrations of undesirable gases relative to the gas capture systems 162 and/or 166, while the gas capture system 166 may be designed to handle low or intermediate concentrations of undesirable gases relative to the gas capture systems 162 and/or 164. For example, the gas capture system 164 may be designed to handle concentrations of CO₂ of at least 10, 20, 30, 40, 50, 60, 70, 80, 90, 100, 110, 120, 130, 140, 150, or more times greater than the gas capture system 162, whereas the gas capture system 166 may be designed to handle concentrations of CO₂ of at least 2, 3, 4, 5, 6, 7, 8, 9, 10, or more times greater than the gas capture system 162. By further example, the gas capture system 164 may be designed to handle concentrations of CO₂ of at least 10, 11, 12, 13, 14, 15, 16, 17, 18, 19, 20, 21, 22, 23, 24, 25, or more times greater than the gas capture system 166. By further example, the gas capture system 166 may be designed to handle concentrations of CO₂ of at least 1, 2, 3, 4, 5, 6, 7, 8, 9, 10, or more percent relative to the concentrations of CO₂ handled by the gas capture system 162. In one embodiment, the gas capture systems 164 and 166 may capture approximately 95 percent and 4.5 percent, respectively, of a total concentration of CO₂ in the exhaust gas flow 68, leaving a remaining 0.5 percent for discharge to the exhaust stack 214. In another embodiment, the gas capture systems 164 and 166 may capture approximately 90 percent and 9.5 percent, respectively, of a total concentration of CO₂ in the exhaust gas flow 68, leaving a remaining 0.5 percent for discharge to the exhaust stack 214.

In certain embodiments, the gas capture system 164 may be designed to handle inlet CO₂ concentrations of about 60,000 ppmw (parts per million by weight) (e.g., capture at least 70, 75, 80, 85, 90, 95 or more percent of the CO₂), whereas the gas capture system 162 may be designed to handle inlet CO₂ concentrations of about 643 ppmw (e.g., capture at least 50, 60, 70, 80, or more percent of the CO₂), and whereas the gas capture system 166 may be designed to handle inlet CO₂ concentrations of about 3,000 ppmw (e.g., capture at least 50, 60, 70, 80, 90 or more percent of the CO₂). In certain embodiments, the gas capture system 164 may be designed to capture about 25,000 to 100,000 ppmw of CO₂, whereas the gas capture system 162 may be designed to capture about 100 to 300 ppmv of CO₂, and whereas the gas capture system 166 may be designed to capture about 1,000 to 10,000 ppmw of CO₂. In some embodiments, the gas capture system 164 may be designed to capture at least 70, 75, 80, 85, 90, 95, or greater percent of a total CO₂ concentration in the exhaust gas flow 68, while the gas capture systems 162 and/or 166 may be designed to capture substantially all or part of the remaining CO₂ otherwise present in the exhaust gas flow 68 (e.g., at least 70, 80, 85, 90, or 95 percent of the remaining CO₂). The carbon capture by the gas capture system 162, which removes undesirable gases (e.g., CO₂) from the air intake flow 60, indirectly reduces the presence of the undesirable gases in the exhaust gas flow 68.

In one particular embodiment, the gas capture system 164 may be designed to capture approximately 95 percent of a total CO₂ concentration in the exhaust gas flow 68 (e.g., 95 percent of 60,000 ppmw, resulting in gas capture of 57,000 ppmw of CO₂), while the gas capture systems 162 and/or 166 may be designed to capture substantially all or part of the remaining 5 percent of the total CO₂ concentration in the exhaust gas flow 68 (e.g., 2.5, 3, 3.5, 4, 4.5, or 5 percent of 60,000 ppmw, resulting in partial or complete capture of another 3,000 ppmw of CO₂). For example, the gas capture systems 162 and/or 166 may capture 90 percent of the remaining 5 percent (or effectively 4.5 percent) of the total CO₂ concentration (e.g., 90 percent of 3,000 ppmw of CO₂), resulting in only 300 ppmw of CO₂ in the treated exhaust gas flow 68 delivered to the exhaust stack 214. This particular embodiment would result in a net negative carbon footprint for the combined cycle power plant 10. However, a variety of configurations of the gas capture systems 160 (e.g., 162, 164, and 166) are contemplated by the present disclosure in order to achieve a net neutral or net negative carbon footprint for the combined cycle power plant 10.

In some embodiments, each of the gas capture systems 162, 164, and 166 may include a number of modular gas capture units, wherein each of the modular gas capture units has a common capacity, and the number of modular gas capture units is selected based on the concentration levels (e.g., CO₂ levels) in the gas being treated at the particular gas capture system 162, 164, or 166. The modular gas capture units also may include modular sorbent-based gas capture units, modular solvent-based gas capture units, or a combination thereof. In this manner, the gas capture systems 162, 164, and 166 may be assembled and scaled to demands of a particular location and application, using the same or different types of gas capture technologies.

As discussed above, the control system 144 and the monitoring system 146 are communicatively coupled to the gas capture systems 160 and various sensors 148 to provide monitoring and control of the gas capture of undesirable gases (e.g., CO₂). For example, the sensors 148 may include gas composition sensors configured to provide concentration levels of the undesirable gases (e.g., CO₂) and other gases (e.g., oxygen, hydrogen) upstream, within, and/or downstream from each of the gas capture systems 160. The sensors 148 also may include temperature, pressure, and flow rate sensors configured to provide associated feedback regarding the flows of gas (e.g., air, exhaust gas) being treated by the gas capture systems 160, and flows of steam or other fluids being used in support of the gas capture systems 160. The control system 144 may use the sensor feedback to adjust operation of the gas capture systems 160, such as by adjusting characteristics of steam or other fluids (e.g., temperature, pressure, flow rate, and/or flow paths) in the gas capture systems 160, adjusting residence times in the gas capture systems 160, activating or deactivating one or more of the gas capture systems 160, adjusting the dryers (e.g., 200, 210, and 218), adjusting the fans 202, adjusting the valves 204, adjusting the HRSG 14 and/or extraction of the heated fluid 168 (e.g., content and conditions of steam and/or water, extraction points, etc.), adjusting the gas turbine engine 12 (e.g., adjusting fuel/air ratio, combustion characteristics, fuel type, fuel additives, etc.), or any combination thereof, depending on concentration levels of the undesirable gases. By adjusting various aspects of the gas treatment system 18 (e.g., multiple stages of gas capture systems 160) in coordination with the gas turbine engine 12 and the HRSG 14, the combined cycle power plant 10 may be configured to provide a net neutral or net negative carbon footprint.

The gas capture systems 160 (e.g., 162, 164, and 166) may be configured in a variety of ways depending on the particular demands and CO₂ concentration levels of the combined cycle power plant 10. Table 1 presents various scenarios for the gas capture systems 162, 164, and 166 in the combined cycle power plant 10. The following scenarios indicate each of the gas capture systems 162, 164, and 166 as either n/a (e.g., not present or active), sorbent-based such as described below with reference to FIG. 2, or solvent-based such as described below with reference to FIG. 3. The sorbent-based and solvent-based gas capture systems each may use the heated fluid 168 (e.g., steam and/or heated water) from the HRSG 14 and/or waste heat from the waste heat recover system 172 (e.g., 182, 184, and/or 186) as heat sources for the gas capture processes. Additionally, for each of the following scenarios, the sorbent-based systems may be the same or different in type, configuration, capacity, residence time, and/or any other characteristics. Similarly, for each of the following scenarios, the solvent-based systems may be the same or different in type, configuration, capacity, residence time, and/or any other characteristics. Finally, for each of the following scenarios, each of the gas capture systems 162, 164, and 166 may include one or more stages and/or parallel flows of gas capture.

TABLE 1
Gas Capture System Scenarios

| | Gas Capture | Gas Capture | Gas Capture |
|---|---|---|---|
| | System 162 | System 164 | System 166 |
| Scenario | (Air Intake) | (Exhaust) | (Exhaust) |
| 1 | Sorbent-Based | Sorbent-Based | Sorbent-Based |
| 2 | Solvent-Based | Sorbent-Based | Sorbent-Based |
| 3 | Solvent-Based | Solvent-Based | Sorbent-Based |
| 4 | Solvent-Based | Sorbent-Based | Solvent-Based |
| 5 | Solvent-Based | Solvent-Based | Solvent-Based |
| 6 | Sorbent-Based | Solvent-Based | Sorbent-Based |
| 7 | Sorbent-Based | Sorbent-Based | Solvent-Based |
| 8 | Sorbent-Based | Solvent-Based | Solvent-Based |
| 9 | n/a | Sorbent-Based | Sorbent-Based |
| 10 | n/a | Solvent-Based | Sorbent-Based |
| 11 | n/a | Sorbent-Based | Solvent-Based |
| 12 | n/a | Solvent-Based | Solvent-Based |
| 13 | Sorbent-Based | n/a | Sorbent-Based |
| 14 | Solvent-Based | n/a | Sorbent-Based |
| 15 | Sorbent-Based | n/a | Solvent-Based |
| 16 | Solvent -Based | n/a | Solvent-Based |
| 17 | Sorbent-Based | Sorbent-Based | n/a |
| 18 | Solvent-Based | Sorbent-Based | n/a |
| 19 | Sorbent-Based | Solvent-Based | n/a |
| 20 | Solvent-Based | Solvent-Based | n/a |

As indicated above, the disclosed embodiments include at least 20 scenarios for the gas capture systems 162, 164, and 166. Additional scenarios are also contemplated using other gas capture technologies and/or variations in the sorbent-based and solvent-based gas capture systems. With the foregoing in mind, FIGS. 2 and 3 present embodiments of the sorbent-based and solvent-based gas capture systems.

FIG. 2 is a schematic of an embodiment of a gas capture system 160 of the multi-stage gas treatment system 18 of FIG. 1, illustrating a sorbent-based gas capture system 250. In the illustrated embodiment, the sorbent-based gas capture system 250 includes a sorbent-based gas capture assembly or unit 252 (e.g., adsorbers or adsorption units) having a plurality of sorbent-containing conduits 254, such as sorbent-containing conduits 256 and 258. The sorbent-containing conduits 254 (e.g., 256 and 258) may be sorbent-lined along interior surfaces, sorbent-packed within interior volumes, or generally filled with at least 10, 20, 30, 40, 50, 60, 70, 80, 90, or more percent by volume of sorbent material. However, the sorbent-based gas capture unit 252 may include any number of sorbent-containing conduits 254, such as 2, 3, 4, 5, 6, 7, 8, 9, 10, or more, which are configured in parallel and/or series. Each of the sorbent-containing conduits 254 (e.g., 256 and 258) includes an outer conduit wall 260 disposed circumferentially about a flow path 262 along a central axis 264 from an inlet 266 to an outlet 268, wherein a sorbent material 270 is disposed along and/or within a central bore or interior surface 272 of the outer conduit wall 260.

The sorbent material 270 (e.g., solid adsorbents) may cover, coat, or generally line at least 50, 60, 70, 80, 90, 95, or 100 percent of the interior surface 272 of the outer conduit wall 260. Additionally or alternatively, the sorbent material 270 may at least partially fill or pack an interior volume of the central bore or interior surface 272, such that voids remain to facilitate fluid flow (e.g., a void fraction of less than or equal to 10, 20, 30, 40, or 50 percent). For example, the sorbent material 270 may include a plurality of particles, beads, strips, strands, mesh, or other distributed structures, which leave voids for fluid flow. In certain embodiments, the sorbent material 270 may be coupled to one or more interior structures within the sorbent-containing conduits 254, such as, for example, one or more of a wire grid or mesh, radial projections, baffles, fins, honeycomb structures, or any combination thereof. Furthermore, in some embodiments, the central axis 264 extending from the inlet 266 to the outlet 268 may define flow path 262 as a linear flow path, a curved flow path, a winding or serpentine flow path, a spiral or helical flow path, a tortuous flow path, an expanding and contracting flow path, a flow path with splits and/or unions, or any combination thereof. For example, the flow path 262 may be defined as a tortuous flow path and include any number or configuration of the foregoing flow paths. The sorbent material 270 may include one or more sorbent materials configured to adsorb the undesirable gases, such as sorbent materials designed or suitable for adsorption of carbon oxides (CO_{X}) such as carbon dioxide (CO₂) and carbon monoxide (CO), nitrogen oxides (NO_{X}), sulfur oxides (SO_{X}) such as sulfur dioxide (SO₂), methane (CH₄), or any other undesirable gases as described herein or subject to regulations and/or considered greenhouse gases. For example, the sorbent materials 270 may include porous, solid-phase materials, including mesoporous silicas, zeolites (e.g., aluminosilicates), and metal-organic frameworks (MOFs) and covalent organic frameworks (COFs). The foregoing sorbent materials 270 may be particularly well-suited for CO₂ adsorption in the sorbent-based gas capture unit 252. However, any suitable sorbent materials 270 may be used depending on the desired target for gas capture of undesirable gases. In certain embodiments, a plurality of the sorbent-based gas capture systems 250 may be used in series, wherein each of the sorbent-based gas capture system 250 uses the same or different sorbent materials 270 to remove and capture the same or different undesirable gases in stages.

The sorbent-based gas capture system 250 may be configured to alternate the various sorbent-based gas capture unit 252 between an adsorption mode (e.g., adsorbing the undesirable gases into the sorbent material 270) and a desorption mode (e.g., desorbing the undesirable gases from the sorbent material 270) using the controller 150 of the control system 144 and the sensors 148 of the monitoring system 146. For example, using the controller 150, the sorbent-based gas capture system 250 may operate the sorbent-based gas capture unit 256 in the adsorption mode while operating the sorbent-based gas capture unit 258 in the desorption mode, and vice versa. The sorbent-based gas capture system 250 also may be configured to operate multiple units (e.g., 2, 3, 4, or more) of the sorbent-based gas capture units 252 in the adsorption mode while operating multiple units (e.g., 2, 3, 4, or more) of the sorbent-based gas capture units 252 in the desorption mode, wherein the multiple units may be arranged in series, in parallel, or a combination thereof. The controller 150 is configured to alternate the sorbent-based gas capture units 252 between the adsorption and desorption modes via a plurality of upstream and downstream systems, such as an upstream flow distribution system 274 and a downstream flow distribution system 276. The upstream flow distribution system 274 includes a heated fluid supply system 278 (e.g., steam and/or heated water supply system) and a gas supply system 280, while the downstream flow distribution system 276 includes a post-desorption processing system 282 (e.g., gas, steam, and/or heated water processing system) and a treated gas processing system 284.

For the desorption mode, the sorbent-based gas capture unit 252 may be configured to route the heated fluid 168 in direct contact with the sorbent material 270 through the sorbent-containing conduits 254 (e.g., direct heat transfer), through or around the sorbent-containing conduits 254 via one or more heat exchange conduits without contacting the sorbent material 270 (e.g., indirect heat transfer), or a combination thereof. Accordingly, in certain embodiments of the desorption mode as discussed below, the sorbent-based gas capture unit 252 may route the heated fluid 168 directly through the sorbent material 270 in the sorbent-containing conduits 254 to desorb the undesirable gases (e.g., CO₂) into the heated fluid 168 to produce a gas/heated fluid flow for further processing, or the sorbent-based gas capture unit 252 may use the heated fluid 168 for indirect heat transfer to the sorbent material 270 for desorption of the undesirable gases while using another flow-inducing system (e.g., a vacuum system) to direct the undesirable gases downstream for further processing. For example, the vacuum system may include one or more fans, blowers, or pumps to draw a flow and/or create a vacuum to induce a flow out of the sorbent-containing conduits 254 into the downstream processing components. Furthermore, in some embodiments, the heated fluid 168 may use steam to heat water to produce a heated water, which is then routed through the sorbent-based gas capture unit 252 for direct contact with the sorbent material 270 and desorption of the undesirable gases from the sorbent material 270. Accordingly, the disclosed embodiments may use a variety of heated fluids 168 (e.g., steam, heated water, fluid heated by steam, or a combination thereof) as a heat source, which may apply heat directly or indirectly to the sorbent materials 270 to facilitate the desorption process.

In certain embodiments, a continuous process, where a wheel of sorbent material 270 is rotated from adsorption, desorption and cooling, can be performed to provide a continuous stream of captured undesirable gases. For example, the wheel of sorbent material 270 may extend into each of the plurality of conduits 254, and continuously rotate through the conduits 254. During the wheel rotation, one or more of the conduits 254 flow the gas 286 being treated to remove the undesirable gases, while one or more of the conduits 254 simultaneously flow the heated fluid 168 (e.g., steam and/or heated water) to remove and capture the undesirable gas (e.g., CO₂) to generate the captured gas 194. For the desorption, the heated fluid 168 (e.g., steam and/or heated water) may be routed or generally configured to provide direct heat transfer and/or indirect heat transfer to the sorbent material 270, thereby helping to separate and capture the undesirable gas.

In the illustrated embodiment, the upstream flow distribution system 274 is configured to distribute flows and alternate flows (e.g., when changing between the adsorption and desorption modes) of the heated fluid 168 (e.g., steam and/or heated water) and a gas 286 (e.g., intake air flow 60 and/or exhaust gas flow 68) to the plurality of sorbent-containing conduits 254 (e.g., 256 and 258) of the sorbent-based gas capture unit 252. The heated fluid supply system 278 includes one or more steam supplies, heated water supplies, and/or waste heat supplies, such as the HRSG 14 and the waste heat recovery system 172 (e.g., 182, 184, and/or 186), configured to generate the heated fluid 168 (e.g., steam and/or heated water). The heated fluid supply system 278 also includes a heated fluid control 288 (e.g., steam and/or heated fluid control) having one or more heated fluid control components 290, 292, and 294, which may be configured to process, adjust, and/or control characteristics of the heated fluid 168 upstream from the sorbent-containing conduits 254 (e.g., 256 and 258) of the sorbent-based gas capture unit 252. For example, the heated fluid control component 290 may include a thermal control component (e.g., steam/hot water temperature control component), such as a heat exchanger, a heater, a cooler, or any combination thereof, configured to adjust (e.g., increase or decrease) a temperature of the heated fluid 168. The heat exchanger may exchange heat with water, lubricant, coolant, refrigerant, or some other thermal fluid. In some embodiments, the waste heat recovery system 172 may be used for heat transfer in the heater exchanger. The heated fluid control component 292 may include a pressure control component, such as a pressure regulator, an expander or expansion chamber, a constrictor or constriction chamber, a fan or pump to add energy, a turbine to extract energy, or another suitable pressure controller. The heated fluid control component 294 may include a pre-treatment component, such as a particulate filter, a cold water drain, and/or other pre-treatment components configured to alter characteristics of the heated fluid 168 (e.g., steam and/or heated water) or remove contaminants. The heated fluid supply system 278 also may include one or more valves 296 configured to control the distribution of the heated fluid 168 (e.g., steam and/or heated water) to the plurality of sorbent-containing conduits 254 (e.g., 256 and 258) of the sorbent-based gas capture unit 252, as indicated by distribution conduits or lines 298 and 300. For example, the valves 296 may include one or more 2-way valves, 3-way valves, or distribution manifolds to distribute the heated fluid 168 (e.g., steam and/or heated water) in response to control signals from the controller 150.

For the distribution of the gas 286, the gas supply system 280 of the upstream flow distribution system 274 includes a gas pre-treatment 302 having one or more gas pre-treatment components 304, 306, and 308, which may be configured to process, adjust, and/or control characteristics of the gas 286 (e.g., intake air flow 60 or exhaust gas flow 68) upstream from the sorbent-containing conduits 254 (e.g., 256 and 258) of the sorbent-based gas capture unit 252. For example, the gas pre-treatment component 304 may include a thermal control component (e.g., gas temperature control component), such as a heat exchanger, a heater, a cooler, or any combination thereof, configured to adjust (e.g., increase or decrease) a temperature of the gas 286. The heat exchanger may exchange heat with water, exhaust gas, compressor bleed flow, waste heat, or some other thermal fluid. In some embodiments, the waste heat recovery system 172 may be used for heat transfer in the heater exchanger. The gas pre-treatment component 306 may include a pressure control component, such as a pressure regulator, an expander or expansion chamber, a constrictor or constriction chamber, a fan or pump to add energy, a turbine to extract energy, or another suitable pressure controller. The gas pre-treatment component 308 may include one or more contaminant removal units, such as a particulate filter, a moisture removal unit or dryer, a chemical removal unit, and/or other removal units configured clean the gas 286. The gas supply system 280 also may include one or more valves 310 configured to control the distribution of the gas 286 to the plurality of sorbent-containing conduits 254 (e.g., 256 and 258) of the sorbent-based gas capture unit 252, as indicated by distribution conduits or lines 312 and 314. For example, the valves 310 may include one or more 2-way valves, 3-way valves, or distribution manifolds, perforated plates and/or flow distribution packing to distribute the gas 286 in response to control signals from the controller 150.

The downstream flow distribution system 276 is configured to distribute flows and alternative flows (e.g., when changing between the adsorption and desorption modes) from the plurality of sorbent-containing conduits 254 (e.g., 256 and 258) of the sorbent-based gas capture unit 252 to the post-desorption processing system 282 and the treated gas processing system 284. The post-desorption processing system 282 may include one or more valves 316 configured to control the distribution of a captured gas/heated fluid flow (e.g., gas, steam, and/or heated water) from the plurality of sorbent-containing conduits 254 (e.g., 256 and 258) of the sorbent-based gas capture unit 252, as indicated by distribution conduits or lines 318 and 320. For example, the valves 316 may include one or more 2-way valves, 3-way valves, or manifolds to collect the captured gas/heated fluid flow in response to control signals from the controller 150. In certain embodiments, the captured gas/heated fluid flow is a result of the desorption mode, wherein the heated fluid 168 (e.g., steam and/or heated water) is directed through the sorbent-containing conduit 254 to desorb the undesirable gases (e.g., CO₂) from the sorbent material 270 in the respective sorbent-containing conduit 254. Accordingly, the post-desorption processing system 282 also may include a post-desorption processor 322 having one or more post-desorption processing components 324, 326, and 328 (e.g., gas, steam, and/or heated water processing components), which may be configured to process, adjust, and/or control characteristics of the captured gas/heated fluid flow (e.g., gas, steam, and/or heated water flow) from the sorbent-containing conduits 254 (e.g., 256 and 258) of the sorbent-based gas capture unit 252. For example, the post-desorption processing component 324 may include a captured gas/heated fluid separator configured to separate the heated fluid 168 (e.g., steam and/or heated water) from the captured gas, thereby outputting a water 330 (e.g., condensate) and the captured gas 194. Examples of the captured gas/heated fluid separator include thermal control components, pressure control components, chemical separation components, or a combination thereof. For example, the captured gas/heated fluid separator may be configured to condense or cool the heated fluid 168 using a condenser. The post-desorption processing component 326 may include one or more removal units configured to remove contaminants from the water 330 and/or the captured gas 194. For the water 330, the removal units may include particulate filters and/or water treatment units. For the captured gas 194, the removal units may include particulate filters, water removal units or dryers, or further gas treatment units. The post-desorption processing component 328 may include one or more pressure control components and/or flow control components, such as one or more pumps for the water 330 and one or more compressors for the captured gas 194. The post-desorption processing components 328 also may include one or more vacuum pumps configured to suction the captured gas/heated fluid flow from the sorbent-based gas capture unit 252.

For the distribution of the gas 286, the treated gas processing system 284 of the downstream flow distribution system 276 may include one or more valves 332 configured to control the distribution of treated gas flow from the plurality of sorbent-containing conduits 254 (e.g., 256 and 258) of the sorbent-based gas capture unit 252, as indicated by distribution conduits or lines 334 and 336. For example, the valves 332 may include one or more 2-way valves, 3-way valves, or manifolds to collect the treated gas flow in response to control signals from the controller 150, thereby outputting a treated gas 338. The treated gas is a result of the adsorption mode, wherein the gas 286 (e.g., intake air flow 60 or exhaust gas flow 68) is directed through the sorbent-containing conduit 254 to adsorb the undesirable gases (e.g., CO₂) into the sorbent material 270 in the respective sorbent-containing conduit 254, thereby reducing the content or concentration levels of the undesirable gases in the remaining treated gas flow.

The control system 144 (e.g., controller 150) is configured to receive feedback from the sensors 148 to facilitate adjustments of various operating parameters of the sorbent-based gas capture unit 252. For example, the control system 144 may be configured to alternate flows (e.g., heat fluid 168 and gas 286) through the plurality of sorbent-containing conduits 254 (e.g., 256 and 258), such that the sorbent-containing conduits 254 can alternate between adsorption and desorption modes. In the adsorption mode, the sorbent-containing conduit 254 (e.g., 256 or 258) receives a flow of the gas 286, adsorbs the undesirable gases (e.g., CO₂) from the gas 286 into the sorbent material 270, and outputs gas 286 with a reduced content or concentration level of the undesirable gases as the treated gas 338. The adsorption mode is an exothermic process, which generates heat that is carried away along with the treated gas 338. In the desorption mode, the sorbent-containing conduit 254 (e.g., 256 or 258) receives a flow of the heated fluid 168 (e.g., steam and/or heated water), desorbs the undesirable gases (e.g., CO₂) from the sorbent material 270 into the heated fluid 168, and outputs the heated fluid 168 with the desorbed undesirable gases (e.g., rich in the undesirable gases such as CO₂) as the captured gas/heated fluid flow. The desorption mode is an endothermic process, and the heated fluid 168 provides sufficient heat (e.g., directly or indirectly) to drive the desorption of the undesirable gases (e.g., CO₂) from the sorbent material 270. The control system 144 is configured to monitor the sensors 148, such as sensors 148 at or upstream from the inlets 266 and sensors 148 at or downstream from the outlets 268, to evaluate rates of adsorption and desorption, concentration levels of the undesirable gases, and other characteristics impacting the adsorption and desorption modes in the respective sorbent-containing conduits 254 (e.g., 256 and 258). If the sensors 148 indicate a need to alternate modes (e.g., adsorption and desorption modes) of the sorbent-containing conduits 254 (e.g., 256 and 258), then the control system 144 may be configured to control the valves 296, 310, 316, and 332 to change from a flow of heated fluid 168 to gas 286 in one of the sorbent-containing conduits 254 and to change from a flow of gas 286 to heated fluid 168 in another one of the sorbent-containing conduits 254. For the heated fluid 168 (e.g., steam and/or heated water) used in one of the sorbent-containing conduits 254, the control system 144 may be configured to control the HRSG 14, the waste heat recovery system 172, the heated fluid control 288, or any combination thereof, to control characteristics of the heated fluid 168 (e.g., temperature, pressure, flow rate, steam content, water content, etc.). For the gas 286 used in one of the sorbent-containing conduits 254, the control system 144 may be configured to control the gas pre-treatment 302 to control characteristics of the gas 286 (e.g., temperature, pressure, flow rate, etc.). Similarly, the control system 144 is configured to control the post-desorption processor 322 to control the processing of captured gas/heated fluid discharged from one or more of the sorbent-containing conduits 254. For the multi-stage gas treatment system 18, the control system 144 also coordinates control between the plurality of gas capture system 160, thereby providing a desired reduction in concentration levels of the undesirable gas (e.g., CO₂) to achieve a net neutral or net negative carbon footprint. In addition, after desorption is completed and prior to adsorption, a stream of cold water or other coolant can be applied through sorbent-based gas capture unit 252 to cool down the sorbent-containing conduits 254 to the desired temperatures prior to the next adsorption step.

FIG. 3 is a schematic of an embodiment of a gas capture system 160 of the multi-stage gas treatment system 18 of FIG. 1, illustrating a solvent-based gas capture system 350. The solvent-based gas capture system 350 includes an absorber 352, a solvent supply system 354, and a solvent discharge system 356. The solvent-based gas capture system 350 may use one or more solvents for capturing the undesirable gases. Example solvents include monoethanolamine (MEA), diglycolamine (DGA), advanced amine solvents, amino acid salts, carbonate solvents, aqueous ammonia, immiscible liquids, and ionic liquids. As discussed below, the solvent-based gas capture system 350 uses the heated fluid 168 (e.g., from the HRSG 14) and/or waste heat (e.g., from the waste heat recovery system 172) to facilitate the gas capture of undesirable gases.

As discussed in further detail below, the solvent supply system 354 is configured to supply a gas lean solvent 358 into the absorber 352 through a conduit 360 coupled to a solvent distributor 362 having a plurality of nozzles 364. The nozzles 364 are configured to output a solvent dispersion 366 into an interior volume 368 of the absorber 352. The solvent dispersion 366 helps to distribute the gas lean solvent 358 more uniformly throughout the interior volume 368, such that the solvent has a more uniform temperature distribution when flowing downwardly through the absorber 352 toward the solvent discharge system 356. The conduit 360 is coupled to a solvent inlet 370 of the absorber 352, while the solvent discharge system 356 is coupled to a solvent outlet 372 of the absorber 352.

The solvent discharge system 356 is configured to receive a gas rich solvent 374 from the solvent outlet 372 and route the gas rich solvent 374 to a solvent regeneration system 376. The solvent discharge system 356 also includes a gas compressor 378 downstream from the solvent regeneration system 376, a gas dryer 380 downstream from the gas compressor 378, and an outlet of a captured gas 194 downstream from the gas dryer 380. The solvent discharge system 356 also provides a return conduit 382 from the solvent regeneration system 376 back to the solvent supply system 354, such that a regenerated solvent may be returned back to the solvent supply system 354 as a gas lean solvent 358.

The absorber 352 also includes a gas inlet 384 configured to receive a gas 286 (e.g., intake air flow 60 or exhaust gas flow 68) into the absorber 352, and a gas outlet 386 configured to discharge a treated gas 338 out of the absorber 352. In the illustrated embodiment, the absorber 352 includes a vessel or enclosure 388 having a top portion 390, a bottom portion 392, and an intermediate portion 394 disposed axially between the top and bottom portions 390 and 392 relative to a central axis 396 of the enclosure 388. In the following discussion, reference may be made to an axial direction or axis 398 disposed along the central axis 396, a radial direction or axis 400 crosswise or perpendicular to the central axis 396, and a circumferential direction or axis 402 extending circumferentially about the central axis 396. The top portion 390 includes a top plate or cover 404 having the gas outlet 386 coaxial with the central axis 396. However, the gas outlet 386 may be disposed offset from the central axis 396 or at other locations along the top portions 390.

The intermediate portion 394 includes a sidewall 406 extending in the circumferential direction 402 about the central axis 396. For example, the sidewall 406 may be an annular sidewall, a square shaped sidewall, a rectangular sidewall, or any other suitable shape that extends around the central axis 396. In certain embodiments, the gas outlet 386 may be disposed in the sidewall 406 along the top portion 390. Additionally, the solvent inlet 370 may be disposed along the top plate or cover 404 or the sidewall 406 in the top portion 390.

The bottom portion 392 may include a base plate 408 below the gas inlet 384 and the solvent outlet 372. In the illustrated embodiment, the gas inlet 384 and the solvent outlet 372 are disposed in the sidewall 406 along the bottom portion 392. However, in certain embodiments, the gas inlet 384 and/or the solvent outlet 372 may be disposed in the base plate 408 in the bottom portion 392. In some embodiments, the gas inlet 384 may include a plurality of gas inlets and/or the solvent outlet 372 may include a plurality of solvent outlets.

Within the interior volume 368 of the absorber 352, the absorber 352 may further include one or more sets of a packing 410, a support tray or screen 412, and a solvent distributor 414 having a plurality of nozzles 416. For example, in the illustrated embodiment, the absorber 352 includes four sets of components (e.g., the packing 410, the support tray or screen 412, and the solvent distributor 414) disposed between the solvent distributor 362 and the bottom portion 392 having the gas inlet 384 and the solvent outlet 372. The packing 410 may include a plurality of beads, balls, or mixture inducing structures, which are configured to facilitate mixing between the gas 286 and the gas lean solvent 358 being supplied into the interior volume 368 of the absorber 352. The support tray or screen 412 may include a wire mesh, a plate having a plurality of openings, or another suitable structure that holds the packing 410 in position while permitting fluid flow of gas and solvent through the support tray or screen 412 in opposite directions through the absorber 352. The solvent distributor 414 may be similar to the solvent distributor 362, and thus the nozzles 416 may be distributed in a uniform manner throughout the interior volume 368 to output a solvent dispersion 418 to better distribute the solvent passing through the packing 410 and the support tray or screen 412. The sets of the packing 410, the support tray or screen 412, and the solvent distributor 414 are spaced apart from one another along the central axis 396. However, the spacing may be increased or decreased or even eliminated in certain embodiments of the absorber 352.

In operation, the absorber 352 is configured to create a cross-flow or opposing flow of the gas lean solvent 358 and the gas 286 within the interior volume 368, thereby facilitating gas absorption of certain undesirable gases (e.g., CO₂) from the gas 286 into the gas lean solvent 358. As illustrated, at the bottom portion 392, the gas 286 enters the absorber 352 through the gas inlet 384, and the gas 286 flows upwardly through the interior volume 368 of the absorber 352 as indicated by arrows 420. The gas 286 entering the absorber 352 as indicated by arrows 420 may form bubbles of the gas 286 that rise upwardly through the gas lean solvent 358 within the interior volume 368. The gas 286 then passes through each subsequent stage or set of the packing 410, the support tray or screen 412, and the solvent distributor 414.

At the top portion 390, the solvent supply system 354 feeds the gas lean solvent 358 into the interior volume 368 through the solvent inlet 370, the conduit 360, the solvent distributor 362, and the plurality of nozzles 364. Again, the nozzles 364 may be distributed at various positions across the interior volume 368 to help distribute the gas lean solvent 358 more uniformly throughout the interior volume 368, as indicated by the solvent dispersions 366. The gas lean solvent 358 then flows downwardly through the interior volume 368 through each subsequent set or stage of the packing 410, the support tray or screen 412, and the solvent distributor 412 having the nozzles 416. As the gas lean solvent 358 passes through each packing 410, the various beads, balls, or mixing structures in the packing 410 are configured to help mix the gas lean solvent 358 with the gas 286, thereby helping to absorb various undesirable gases from the gas 286 into the gas lean solvent 358. For example, the gas lean solvent 358 may be configured to absorb carbon dioxide (CO₂) or other undesirable gases as discussed in detail above. As the absorption process occurs, heat is generated within the absorber 352, thereby raising the temperature of the solvent within the absorber 352. In certain embodiments, a thermal control system (e.g., heat exchanger, coolers, etc.) may be coupled to the absorber 352 to control the temperatures, and improve the efficiency of the absorption process. The absorption process continues within each set or stage of the packing 410, the support tray or screen 412, and the solvent distributor 414. Between each stage or set, the solvent distributor 414 helps to better distribute the solvent as indicated by the solvent dispersions 418. The solvent dispersions 418 may help to uniformly mix the solvent with the gas 286 and prove more uniformity in the temperature distribution. The absorption process then repeats in the next set or stage of the packing 410, the support tray or screen 412, and the solvent distributor 414.

Eventually, the absorber 352 discharges a gas rich solvent 374 at the bottom portion 392 through the solvent outlet 372, and the absorber 352 discharges the treated gas 338 at the top portion 390 through the gas outlet 386. The treated gas 338 may be substantially free or stripped of one or more undesirable gases (e.g., CO₂). In contrast, the gas rich solvent 374 may have absorbed the one or more undesirable gases (e.g., CO₂). Accordingly, the gas rich solvent 374 may be described as a CO₂ rich solvent (or other gas rich solvent depending on the undesirable gas), while the gas lean solvent 358 may be described as a CO₂ lean solvent (or other gas lean solvent depending on the undesirable gas) and the particular gas absorption occurring in the absorber 352. Similarly, the gas 352 may be described as a CO₂ containing or rich gas (or other containing or rich gas depending on the undesirable gas), while the treated gas 338 may be described as a CO₂ reduced, lean, or free gas (or other reduced, lean, or free gas depending on the undesirable gas) and the particular gas absorption occurring in the absorber 352. The gas absorption discussed herein is intended to cover any one or more of the undesirable gases described herein, or any other regulated or greenhouse gases.

The gas rich solvent 374 output from the absorber 352 flows into the solvent regeneration system 376, which may be configured to capture the undesirable gases (e.g., CO₂) in the gas rich solvent 374 and regenerate the solvent (e.g., remove the undesirable gases (e.g., CO₂) for reuse of the solvent as the gas lean solvent 358). In the illustrated embodiment, the solvent-based gas capture system 350 comprises a steam supply system 422 coupled to the solvent regeneration system 376 to facilitate solvent regeneration and capture of the captured gas 194. In particular, the steam supply system 422 includes one or more sources of the heated fluid 168 (e.g., steam and/or heated water), such as the HRSG 14 and/or the waste heat recovery system 172 (e.g., 182, 184, and 186). The steam supply system 422 may inject the heated fluid 168 (e.g., steam and/or heated water) directly into the solvent regeneration system 376 for the solvent regeneration and capture of the captured gas 194. In some embodiments, the steam supply system 422 may further process and/or control characteristics of the heated fluid 168 (e.g., steam and/or heated water) prior to injection into the solvent regeneration system 376, such as, for example, temperature control and/or pressure control. In some embodiments, the steam supply system 422 may use the heated fluid 168 (e.g., steam and/or heated water) and/or the waste heat from the waste heat recovery system 172 as an indirect heat source for the absorber 352 and/or to generate steam in a boiler. In each of these embodiments, the heated fluid 168 (e.g., steam and/or heated water) and the waste heat from the waste heat recovery system 172 may be acquired and/or processed as discussed in detail above with reference to FIGS. 1 and 2.

Accordingly, the undesirable gases (e.g., CO₂) may be output from the solvent regeneration system 376 to the gas compressor 378 as indicated by arrow 424, such that the gas compressor 378 is configured to compress the undesirable gases prior to being dried by the gas dryer 380. The gas dryer 380 then removes any moisture content in the compressed undesirable gases from the gas compressor 378, and then outputs the compressed and dried undesirable gases as the captured gas 194. Additionally, the solvent regeneration system 376 outputs the regenerated solvent as the gas lean solvent 358 being returned to the solvent supply system 354 through the return conduit 382. The regenerated solvent is essentially the gas rich solvent 374 with the undesirable gases removed in the solvent regeneration system 376.

In the solvent supply system 354, the gas lean solvent 358, whether an original supply of gas lean solvent 358 or a regenerated solvent from the solvent regeneration system 376, is supplied into the absorber 352 with one or more components 426, 428, 430, and 432. The components 426, 428, 430, and 432 may include one or more solvent pumps, solvent filters or treatment systems, one or more heat exchangers configured to cool the gas leans solvent 358, one or more solvent tanks, one or more solvent pressure regulators, one or more solvent flow meters, or any combination thereof.

Technical effects of the disclosed embodiments include a multi-stage gas treatment system having a plurality of gas capture systems 160 (e.g., 162, 164, and 166), which may include sorbent-based gas capture systems (e.g., 250, FIG. 2) and/or solvent-based gas capture systems (e.g., 350, FIG. 3) with heated fluid 168 (e.g., steam and/or heated water) and/or waste heat from a waste heat recovery system 172 (e.g., 182, 184, and 186) as a source of heat for the gas capture processes. The discloses embodiments substantially reduce the concentration levels of undesirable gases (e.g., CO₂) to levels at or below input levels, thereby helping to achieve a net neutral or net negative carbon footprint for the combined cycle power plant 10.

The subject matter described in detail above may be defined by one or more clauses, as set forth below.

A system includes a gas treatment system having first and second gas capture systems and a steam supply circuit. The first gas capture system is configured to capture a first portion of an undesirable gas from a combined cycle power plant. The second gas capture system is configured to capture a second portion of the undesirable gas from the combined cycle power plant, wherein the first and second gas capture systems are arranged in series relative to a fluid flow path through the combined cycle power plant. The steam supply circuit includes a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

The system of any preceding clause, including a controller coupled to the gas treatment system and one or more sensors configured to obtain feedback indicative of a concentration level of the undesirable gas, wherein the controller is configured to control the first and second gas capture systems to control the concentration level of the undesirable gas based on one or more threshold concentration levels.

The system of any preceding clause, wherein the controller is configured to control the first and second gas capture systems to control the concentration level of the undesirable gas to be net neutral or net negative for the combined cycle power plant.

The system of any preceding clause, wherein the undesirable gas includes carbon dioxide (CO₂).

The system of any preceding clause, including the combined cycle power plant having a gas turbine system, the HRSG configured to receive an exhaust gas from the gas turbine system, and the steam turbine system configured to receive steam from the HRSG.

The system of any preceding clause, wherein at least one of the first gas capture system or the second gas capture system includes a sorbent-based gas capture system.

The system of any preceding clause, wherein at least one of the first gas capture system or the second gas capture system includes a solvent-based gas capture system.

The system of any preceding clause, wherein each of the first gas capture system and the second gas capture system includes a sorbent-based gas capture system.

The system of any preceding clause, wherein at least one of the first gas capture system or the second gas capture system is configured to be positioned along an air flow path upstream from a combustor of a gas turbine system of the combined cycle power plant.

The system of any preceding clause, wherein at least one of the first gas capture system or the second gas capture system is configured to be positioned along an exhaust flow path of exhaust gas from a gas turbine system of the combined cycle power plant.

The system of any preceding clause, wherein each of the first gas capture system and the second gas capture system is configured to be positioned along an exhaust flow path of exhaust gas from a gas turbine system of the combined cycle power plant.

The system of any preceding clause, wherein each of the first gas capture system and the second gas capture system includes a sorbent-based gas capture system.

The system of any preceding clause, wherein each of the first gas capture system and the second gas capture system is configured to be positioned along the exhaust flow path downstream from the HRSG.

The system of any preceding clause, wherein the sorbent-based gas capture system includes a wheel having a sorbent material, and the wheel is configured to rotate the sorbent material between a first flow path for adsorption of the undesirable gas a second flow path for desorption of the undesirable gas.

The system of any preceding clause, wherein the sorbent-based gas capture system includes a first conduit having a first sorbent material and a second conduit having a second sorbent material, wherein the gas treatment system is configured to alternate flows of the steam and a gas to be treated between the first and second conduits to alternative between respective desorption and absorption modes.

A system includes a controller configured to control a first gas capture system of a gas treatment system to capture a first portion of an undesirable gas from a combined cycle power plant. The controller is configured to control a second gas capture system of the gas treatment system to capture a second portion of the undesirable gas from the combined cycle power plant, wherein the first and second gas capture systems are arranged in series relative to a fluid flow path through the combined cycle power plant. The controller is configured to control a supply of steam to the first and second gas capture systems via a steam supply circuit having a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

The system of the preceding clause, wherein the controller is configured to obtain feedback, via one or more sensors, indicative of a concentration level of the undesirable gas, wherein the controller is configured to control the first and second gas capture systems to control the concentration level of the undesirable gas based on one or more threshold concentration levels.

The system of any preceding clause, wherein the controller is configured to control the first and second gas capture systems to control the concentration level of the undesirable gas to be net neutral or net negative for the combined cycle power plant, wherein each of the first gas capture system and the second gas capture system is configured to be positioned along an exhaust flow path of exhaust gas from a gas turbine system of the combined cycle power plant, wherein each of the first gas capture system and the second gas capture system includes a sorbent-based gas capture system, wherein the undesirable gas includes carbon dioxide (CO₂).

The system of any preceding clause, further including at least one of the first gas capture system, the second gas capture system, the HRSG, the steam turbine system, a gas turbine system, or any combination thereof.

The system of any preceding clause, wherein the sorbent-based gas capture unit is configured to route the heated fluid through or around the sorbent-containing conduits via one or more heat exchange conduits without contacting the sorbent material in an indirect heat transfer manner.

A method includes controlling a first gas capture system of a gas treatment system to capture a first portion of an undesirable gas from a combined cycle power plant. The method also includes controlling a second gas capture system of the gas treatment system to capture a second portion of the undesirable gas from the combined cycle power plant, wherein the first and second gas capture systems are arranged in series relative to a fluid flow path through the combined cycle power plant. The method also includes controlling a supply of steam to the first and second gas capture systems via a steam supply circuit having a first steam supply line coupled to the first gas capture system and a second steam supply line coupled to the second gas capture system. The steam supply circuit is configured to couple to and receive steam from a heat recovery steam generator (HRSG) and/or a steam turbine system of the combined cycle power plant.

This written description uses examples to describe the present embodiments, including the best mode, and also to enable any person skilled in the art to practice the presently disclosed embodiments, including making and using any devices or systems and performing any incorporated methods. The patentable scope of the presently disclosed embodiments is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas treatment system, comprising:
a first gas capture system configured to capture a first portion of an undesirable gas from a combined cycle power plant;
a second gas capture system configured to capture a second portion of the undesirable gas from the combined cycle power plant, wherein the first and second gas capture systems are arranged in series relative to a fluid flow path through the combined cycle power plant; and
a steam supply circuit comprising a first steam supply line coupled to the first gas capture system and a second steam supply line coupled to the second gas capture system, wherein the steam supply circuit is configured to couple to and receive steam from a heat recovery steam generator (HRSG) and/or a steam turbine system of the combined cycle power plant.

2. The system of claim 1, comprising a controller coupled to the gas treatment system and one or more sensors configured to obtain feedback indicative of a concentration level of the undesirable gas, wherein the controller is configured to control the first and second gas capture systems to control the concentration level of the undesirable gas based on one or more threshold concentration levels.

3. The system of claim 2, wherein the controller is configured to control the first and second gas capture systems to control the concentration level of the undesirable gas to be net neutral or net negative for the combined cycle power plant.

4. The system of claim 3, wherein the undesirable gas comprises carbon dioxide (CO₂).

5. The system of claim 4, comprising the combined cycle power plant having a gas turbine system, the HRSG configured to receive an exhaust gas from the gas turbine system, and the steam turbine system configured to receive steam from the HRSG.

6. The system of claim 1, wherein at least one of the first gas capture system or the second gas capture system comprises a sorbent-based gas capture system.

7. The system of claim 6, wherein at least one of the first gas capture system or the second gas capture system comprises a solvent-based gas capture system.

8. The system of claim 1, wherein each of the first gas capture system and the second gas capture system comprises a sorbent-based gas capture system.

9. The system of claim 1, wherein at least one of the first gas capture system or the second gas capture system is configured to be positioned along an air flow path upstream from a combustor of a gas turbine system of the combined cycle power plant.

10. The system of claim 9, wherein at least one of the first gas capture system or the second gas capture system is configured to be positioned along an exhaust flow path of exhaust gas from a gas turbine system of the combined cycle power plant.

11. The system of claim 1, wherein each of the first gas capture system and the second gas capture system is configured to be positioned along an exhaust flow path of exhaust gas from a gas turbine system of the combined cycle power plant.

12. The system of claim 11, wherein each of the first gas capture system and the second gas capture system comprises a sorbent-based gas capture system.

13. The system of claim 12, wherein each of the first gas capture system and the second gas capture system is configured to be positioned along the exhaust flow path downstream from the HRSG.

14. The system of claim 12, wherein the sorbent-based gas capture system comprises a wheel having a sorbent material, and the wheel is configured to rotate the sorbent material between a first flow path for adsorption of the undesirable gas a second flow path for desorption of the undesirable gas.

15. The system of claim 12, wherein the sorbent-based gas capture system comprises a first conduit having a first sorbent material and a second conduit having a second sorbent material, wherein the gas treatment system is configured to alternate flows of the steam and a gas to be treated between the first and second conduits to alternative between respective desorption and absorption modes.

16. A system, comprising:
a controller configured to:
control a first gas capture system of a gas treatment system to capture a first portion of an undesirable gas from a combined cycle power plant;
control a second gas capture system of the gas treatment system to capture a second portion of the undesirable gas from the combined cycle power plant, wherein the first and second gas capture systems are arranged in series relative to a fluid flow path through the combined cycle power plant; and
control a supply of steam to the first and second gas capture systems via a steam supply circuit comprising a first steam supply line coupled to the first gas capture system and a second steam supply line coupled to the second gas capture system, wherein the steam supply circuit is configured to couple to and receive steam from a heat recovery steam generator (HRSG) and/or a steam turbine system of the combined cycle power plant.

17. The system of claim 16, wherein the controller is configured to obtain feedback, via one or more sensors, indicative of a concentration level of the undesirable gas, wherein the controller is configured to control the first and second gas capture systems to control the concentration level of the undesirable gas based on one or more threshold concentration levels.

18. The system of claim 16, wherein the controller is configured to control the first and second gas capture systems to control the concentration level of the undesirable gas to be net neutral or net negative for the combined cycle power plant, wherein each of the first gas capture system and the second gas capture system is configured to be positioned along an exhaust flow path of exhaust gas from a gas turbine system of the combined cycle power plant, wherein each of the first gas capture system and the second gas capture system comprises a sorbent-based gas capture system, wherein the undesirable gas comprises carbon dioxide (CO₂).

19. The system of claim 16, comprising at least one of the first gas capture system, the second gas capture system, the HRSG, the steam turbine system, a gas turbine system, or any combination thereof.

20. A method, comprising:
controlling a first gas capture system of a gas treatment system to capture a first portion of an undesirable gas from a combined cycle power plant;
controlling a second gas capture system of the gas treatment system to capture a second portion of the undesirable gas from the combined cycle power plant, wherein the first and second gas capture systems are arranged in series relative to a fluid flow path through the combined cycle power plant; and
controlling a supply of steam to the first and second gas capture systems via a steam supply circuit comprising a first steam supply line coupled to the first gas capture system and a second steam supply line coupled to the second gas capture system, wherein the steam supply circuit is configured to couple to and receive steam from a heat recovery steam generator (HRSG) and/or a steam turbine system of the combined cycle power plant.
